(19) United States
(12) Patent Application Publication
(10) Pub. No.: US 2002/0018260 A1
(43) Pub. Date: Feb. 14, 2002

(54) Multimedia optical community area network

(76) Inventors: Jean-Francis Kisovec, St-Hubert (CA); Marc Bage, Beloeil (CA); Maroun Massabki, Mont-Royal (CA)

Correspondence Address: SHLESINGER, ARKWRIGHT & GARVEY LLP, 3000 South Eads Street, Arlington, VA, 22202, US

(21) Appl. No.: 09/870,924

(22) Filed: Jun. 1, 2001

(30) Foreign Application Priority Data
Jun. 1, 2000 (GB) 0013366.0

(51) Int. Cl. H04B 10/20; H04J 14/00; H04J 14/02

(52) U.S. Cl. 359/124; 359/118

(57) ABSTRACT

An optical network for the transfer of data between optical network units (ONU) connected to respective data terminal equipment including electro-optical interface for converting electrical signals to optical signals for transmission through the optical network and for converting optical signals to electrical signals for input to the terminal equipment, comprises a fiber optic line having first and second ends; first and second point-of-presence (POP) units connected to respective first and second ends of the fiber optic line, the first and second POP units for being connected to another optical network, the first and second POP units including optical multiple wavelength apparatus for optical signal generation and optical multiple wavelength apparatus for optical signal detection; first and second optical communicators connected to the fiber optic line at locations between the first and second POP units; first and second ONUs operably connected to respective the first and second optical communicators, the first and second ONUs being associated with respective first and second data terminal equipment; the first optical communicator being configured to transmit a first wavelength signal bi-directionally from the first ONU to both the first and second POP units, the first optical communicator including a first add/drop module operably connected to the fiber optic line to drop a second wavelength signal from the fiber optic line intended for the first ONU; the second optical communicator being configured to transmit a third wavelength signal bi-directionally from the second ONU to both the first and second POP units, the second optical communicator including a second add/drop module operably connected to the fiber optic line to drop a fourth wavelength signal from the fiber optic line intended for the second ONU; the first and second ONUs each including optical multiple wavelength apparatus for optical generation and optical wavelength apparatus for optical detection; and control system means for allocating wavelengths between the first and second ONUs and the first and second POP units.

### FIELD OF THE INVENTION

The present invention relates generally to optical data communication networks, and in particular to a scalable, bidirectional, multi-channel, multimedia optical community area network.

claim for priority of British provisional application No. 0013366.0, filed Jun. 1, 2000, is hereby made, the entire disclosure of which is incorporated herein by reference.

### BACKGROUND OF THE INVENTION

Optical networking is expanding from the wide area network to the metropolitan area network (MAN). In the near future, fiber in the loop (FITL) networks, developing at a rapid pace, will become a reality. Most, if not all, FITL architecture are based on a single or dual wavelength star coupling topology. These architectures are not the best solution for network configuration because they lack in their design the capabilities to offer a topology that can be easily integrated in a mesh MAN network. Furthermore, these networks are LAN or MAN oriented and cannot be easily configured to provide both types of network. Rapid growth of local communities and the need to establish local communication without the inconvenience of having to establish contact with distant MAN networks has brought to daylight the need for a network that can easily and rapidly offer LAN and MAN capabilities. Although some architecture proposals include multi-channel configuration (WDM), most of them are based on fixed wavelength allocation, therefore limiting the bandwidth capacity. The optical components that comprise these networks are fixed wavelength components and cannot be actively selected to optimize the network configuration. These architectures are usually based on multi-fiber ring configuration to provide redundancy in case of link failure.

There is, therefore, a need for a multimedia optical community area network aimed at providing a solution to overcome the limitations of the prior art.

### OBJECTS AND SUMMARY OF THE INVENTION

It is an object of the present invention to provide an optical path suitable for application in any data communication network environment.

It is another object of the present invention to provide an optical path suitable for a multi-channel WDM environment.

It is still another object of the present invention to provide a distributed switching mechanism based on wavelength selection at the source in accordance with the assigned wavelength of the receiver.

It is still another object of the present invention to provide an optical path topology that is based on, but not limited to, a bus topology.

It is still another object of the present invention to provide an optical path topology that simultaneously enables connection to a MAN and CAN network.

It is still another object of the present invention to provide an optical path that can achieve selectable-passive or active-add/drop function.

It is still another object of the present invention to provide an optical path that can work as a Community Area Network where ONUs share a common link over which they can communicate among themselves and a Metropolitan Area Network where ONUs do not share a common link and therefore need to communicate among themselves using one or more POPs as intermediate routing or switching platforms.

It is still another object of the present invention to provide an optical path that is bi-directional, enabling communication with both extremities of the light transmission line and enabling redundancy using a single fiber optical transmission line.

It is still another object of the present invention to provide an optical path that can support uni-cast, multicast or broadcast communications.

In summary, the present invention provides an optical network for the transfer of data between optical network units (ONU) connected to respective data terminal equipment including electro-optical interface for converting electrical signals to optical signals for transmission through the optical network and for converting optical signals to electrical signals for input to the terminal equipment, comprising a fiber optic line having first and second ends; first and second point-of-presence (POP) units connected to respective first and second ends of the fiber optic line, the first and second POP units for being connected to another optical network, the first and second POP units including optical multiple wavelength apparatus for optical signal generation and optical multiple wavelength apparatus for optical signal detection; first and second optical communicators connected to the fiber optic line at locations between the first and second POP units with additional optical communicators similarly connected and communicating in pairs in a similar fashion; first and second ONUs operably connected to respective the first and second optical communicators, the first and second ONUs being associated with respective first and second data terminal equipment; the first optical communicator being configured to transmit a first wavelength signal bi-directionally from the first ONU to both the first and second POP units, the first optical communicator including a first add/drop module operably connected to the fiber optic line to drop a second wavelength signal from the fiber optic line intended for the first ONU; the second optical communicator being configured to transmit a third wavelength signal bi-directionally from the second ONU to both the first and second POP units, the second optical communicator including a second add/drop module operably connected to the fiber optic line to drop a fourth wavelength signal from the fiber optic line intended for the second ONU; the first and second ONUs each including optical multiple wavelength apparatus for optical generation and optical wavelength apparatus for optical detection; and control system means for allocating wavelengths between the first and second ONUs and the first and second POP units.

The present invention also provides a method for transferring data between a first optical network unit (ONU) to a second ONU, comprising:

a) providing a fiber optic line between first and second point-of-presence (POP) units;

b) connecting first and second optical communicators to the fiber optic line at locations either between the first and second POP units or attached to the same or different POP units, each optical communicator including add/drop modules;

c) connecting the first and second ONUs to the respective first and second optical communicators;

d) designating one of the first and second POP units to be a primary POP unit for the first ONU; and

e) assigning a wavelength to be used by the first ONU to transmit data signal to the second ONU.

f) adjusting the add/drop module of the second optical communicator to drop the data signal at the assigned wavelength to the second ONU;

g) sending the data signal on the assigned wavelength through the first optical communicator whereby the data signal is sent to both the first and second POP units through the fiber optic link; and

h) informing the primary POP unit that the assigned wavelength is no longer needed.

These and other objects of the present invention will become apparent from the following detailed description.

### BRIEF DESCRIPTIONS OF THE DRAWINGS

FIG. 1 is a schematic diagram of a metropolitan area network including a plurality of community area networks.

FIG. 2 is a schematic diagram of a community area network.

FIG. 3 is a schematic diagram of an optical communicator made in accordance with the present invention.

FIG. 4 is a schematic diagram of a metropolitan area network showing possible pathways for data routing between optical network units located in different community area networks.

FIG. 5 is a schematic diagram of a community area network showing possible pathways for data routing between optical network units.

FIG. 6 is a functional block diagram of the control system used in the present invention.

FIG. 7 is a schematic diagram of a tree-port WDM embodiment of an optical communicator based on thin film filter technology.

FIG. 8 is a schematic diagram of FIG. 7, showing the various signals flowing through the device.

FIG. 9 is a schematic diagram of another embodiment of an optical communicator using circulators and tunable filters.

### DETAILED DESCRIPTION OF THE INVENTION

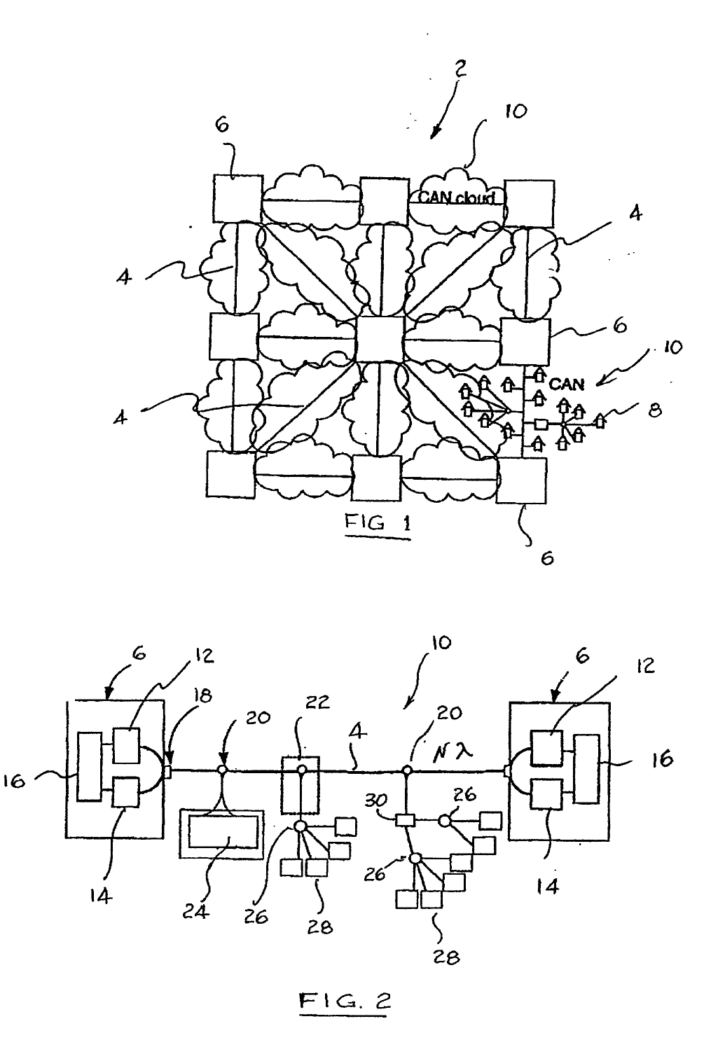

A multimedia MAN optical network 2 is showed schematically in FIG. 1. The network 2 is made of an assembly of optical links 4 that connects points of presence (POP) units 6, such as central offices. The links 4 are bidirectional single fiber optic lines. By virtue of their terminations at two different POP units 6, redundancy is obtained whereby data can flow from either one of the two connected POP units. For additional bandwidth, the links 4 may comprise two or more fiber optic lines. On each link 4, several premises 8 can be connected in several topologies, including the bus topology, to comprise a community area network (CAN) 10. Each POP unit 6 is connected point to point to neighboring POP units. As used herein, a POP unit is a generic term to indicate either a telephony central office, a cable head-end, or a point of presence of a new carrier or internet service provider.

By using this modular architecture, wherein each CAN 10 is considered a module in an overall, larger MAN 2, the CAN 10 can easily be implemented in an existing mesh MAN network. Also this type of modular architecture facilitates further network development. Furthermore, the network can be used as a CAN and MAN network simultaneously, as will be described below.

Referring to FIG. 2, an embodiment of a multimedia optical community area network (MOCAN) 10 is disclosed. Each POP unit 6 comprises optical transmitters 12, optical receivers 14, such as WDM receivers, and the appropriate control circuitry 16 in support of the functions of the transmitters and receivers 12 and 14. The optical transmitters 12 function to convert electrical signals into optical signals. The optical transmitters 12 may be broad-spectrum optical sources including a channel defining assembly, such as channel filter selectors, for resolving the output of the broad-spectrum optical sources. An example of the transmitter 12 is disclosed in U.S. Pat. No. 5,861,965, which is hereby incorporated by reference. The optical transmitters 12 can also be multiple laser sources, WDM laser sources or tunable laser sources. The optical transmitters 12 are standard equipment. In each case, the optical transmitter optical source is controlled by the control circuitry 16. The control circuitry 16 is constantly informed of the network condition by a control system, as will be described below. This information is used to set the wavelengths at the output of the optical source of the transmitter 12 such that no transmitters are set to the same wavelength simultaneously. The wavelength selection is done based on the existing wavelengths propagating in the network. The same wavelength can be used in the same optical link 4 in the multimedia MAN optical network 10 if another multiplex technique such as, but not restricted to, TDM (time-division multiplexing), is used. As mentioned, the optical network units (ONUs) and the neighboring POP units 6 in the multimedia MAN optical network 10 are aware of the network condition, time division segmentation and wavelengths in use via the control channels that are broadcast by the POP units 6. The optical signal generated by the optical transmitters 12 are input to the optical link 4 via a WDM multiplexer 18. Therefore, each of the N optical input channels combined into the optical link are carried by the bus link 6, N being the total number of optical channels active in the CAN network 10.

Each transmitter 12, also called multiple wavelength apparatus, enables the selection of a particular wavelength to be sent into the link 4. The selection of a particular wavelength is made by a control system, as will be described below, according to the destination of the light pulses. For this reason, the CAN 10 is in effect a distributed or virtual switching system.

In the case of a tunable laser source, the latter is modulated at a rate R′ higher than the nominal data rate R of the payload and protocol overhead by a factor of K which depends on the stabilization delay d of the selected wavelength relative to the nominal period T of the data (payload plus protocol) with R′=R/(1−d/T). In the case of a tunable filter, the parameter d in the over-modulation rate R′ is the stabilization delay of the tunable filter passband.

At each node 20, an optical communicator 22 provides the needed functions for proper extraction and input of data and to keep tabs on the network. An electro-optical interface 24, which is connected to a data terminal equipment (not shown), may be connected to the node 20. The node 20 may also be connected to a star coupler 26, which is in turn connected to several ONUs 28. Further, the node 20 may be connected to a smaller switch 30, which connects to various ONUs 28 via star couplers 26. A suitable smaller switch 30 is the 1600™ router manufactured by VIPswitch, Quebec, Canada. Each ONU 28 (see FIG. 6) comprises an electro-optical interface including a transmitter for converting electrical signals to an optical signal for transmission to the network and a receiver for converting light signals received from the network to electrical signals for use by the data terminal. The wavelength selection at the output of each transmitter may be actively controlled by the associated control circuitry that is constantly informed on the network condition by a dedicated control channel, or done in a static way by pre-assignment of wavelengths using tunable filters or tunable lasers or CWDM, DWDM lasers. Examples of data terminal equipment are computers, telephones, television sets, and other multimedia devices.

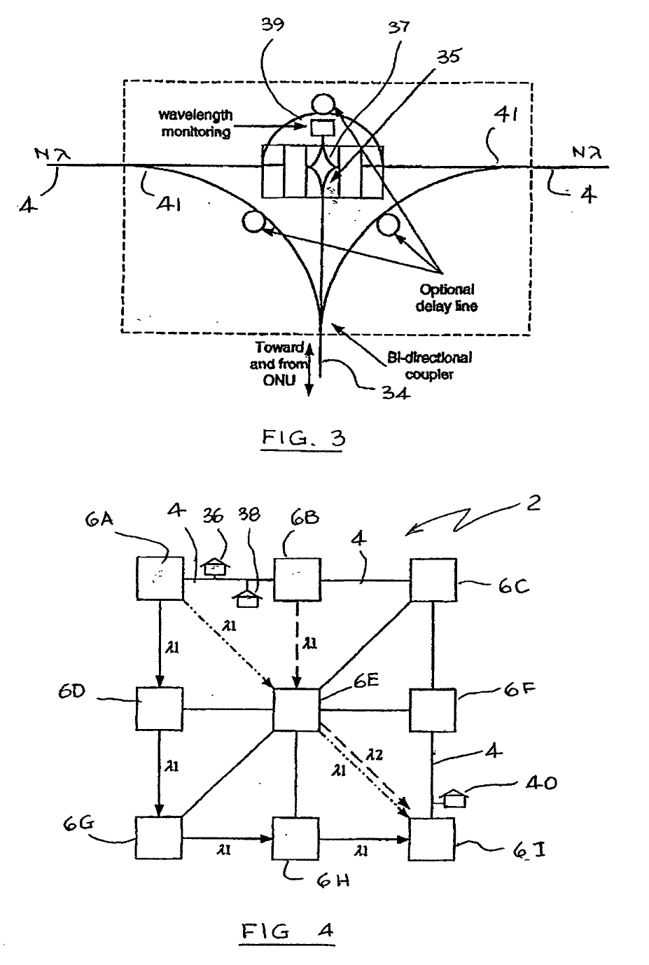

Referring to FIG. 3, an illustrative example of the optical communicator 22 is disclosed. The optical communicator 22 assures bi-directionality to the CAN 10, selects a wavelength filter for proper wavelength routing to its associated ONU and enables collision detect properties of the link 4. The optical communicator 22 can be based on photonic integrated circuits or discrete devices. An add/drop module 32 selects actively or passively the proper wavelength between the N wavelengths launched at the POP unit 6 or any other local node and redirects it to the node's ONU transceiver electro-optical interface that is connected to the node's data terminal equipment. The add/drop module 32 can be made of a circulator and a tunable filter, a tree-port WDM device based on thin-film technology or any device capable of selecting and re-directing a particular wavelength. An optical packet-switching device can be added to the add/drop module to perform time division switching. Bi-directional coupler 34 and splitter 35 (active or passive) assure bi-directionality to the communicator 22. Tap splitters 37 connected to wavelength monitoring 39 assure collision detect capabilities. Couplers 41 connect the device to the optical link 4.

Once the light signal at the proper wavelength is launched toward the link 4 from an ONU, the data is sent bi-directionally along the link and into the network. This enables the signal to reach each node on the link 4 and both POP units 6. From the POP units 6, the data can travel outside the CAN 10 and into the MAN 2. At the POP units 6, a WDM receiver demultiplexes the different wavelengths.

The network can be used simultaneously as a CAN and MAN network, both configurations involving different steps to permit data transfer.

For the MAN configuration, FIG. 4 shows the MAN 2 with POP units 6A, 6B, . . . 6I. ONUs 36, 38 and 40 are connected to the network via their respective links 4. For the same final destination, the routing of information can be done using several pathways. As an example, a client at ONU 36 needs to communicate with another client at ONU 40. ONU 36 is served by POP units 6A and 6B. The network engineer will predetermine the principal and secondary POP unit for each ONU; in this case, the principal POP unit for ONU 36 is POP unit 6A. ONU 36 will send data on a channel (wavelength) that will directly be routed to both POP units 6A and 6B. The bi-directionality of the system assures both POP units receive data and therefore assures redundancy to the link. Because POP unit 6A is the principal POP unit, POP unit 6B will not process data incoming from an ONU to which it is associated as the secondary POP, as in this case with ONU 36. A control channel is broadcast permanently from POP unit 6A and will inform each associated ONU and each neighboring POP unit on the condition of POP unit 6A. In the case of a link failure or abnormal network event, POP unit 6B will automatically take the routing relay for ONU 36 from POP unit 6A. Assuming that everything goes well, the POP unit 6A receives the data from ONU 36. Because ONU 36 needs to communicate with ONU 40, POP unit 6A needs to transfer the data to POP unit 6I which has been designated as the principal POP unit for ONU 40. A possible pathway will be to reach POP unit 6E and then access POP unit 6I and one wavelength λ1 can be used for this connection. When POP unit 6I receives the data, a final data relay at the same or a different wavelength is done to ONU 40, depending on whether or not λ1 is already in use on the CAN link 4 to which ONU 40 is connected. For this communication, other pathways are possible; for example, pathway POP unit 6A to POP unit 6D to POP unit 6G to POP unit 6H and finally POP unit 6I. Also λ1 can be used in this case. Assuming that the first mentioned pathway is selected and in the meantime ONU 38 with principal POP at POP unit 6B needs to reach the same ONU at ONU 40. For this particular connection, POP unit 6E is used to reach POP unit 6I. In this case, a wavelength conversion is needed because interference between data is possible between POP unit 6E and POP unit 6I. Therefore, the wavelength oncoming from POP unit 6B will be converted to λ2, for example, at POP unit 6E, using the multiple wavelength apparatus for optical generation.

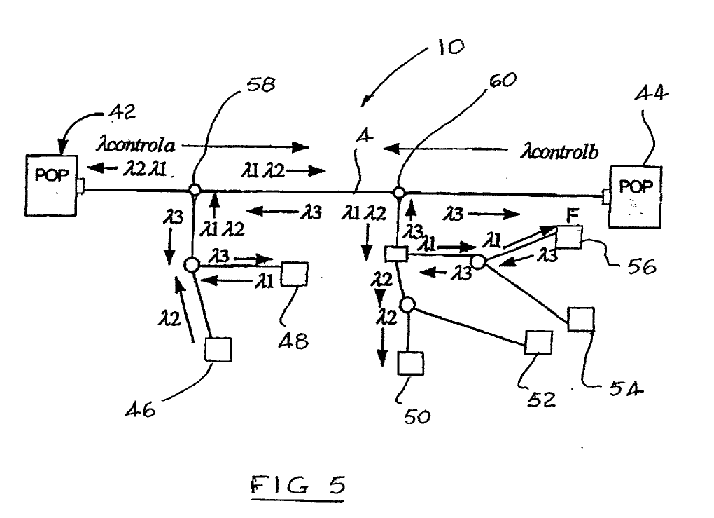

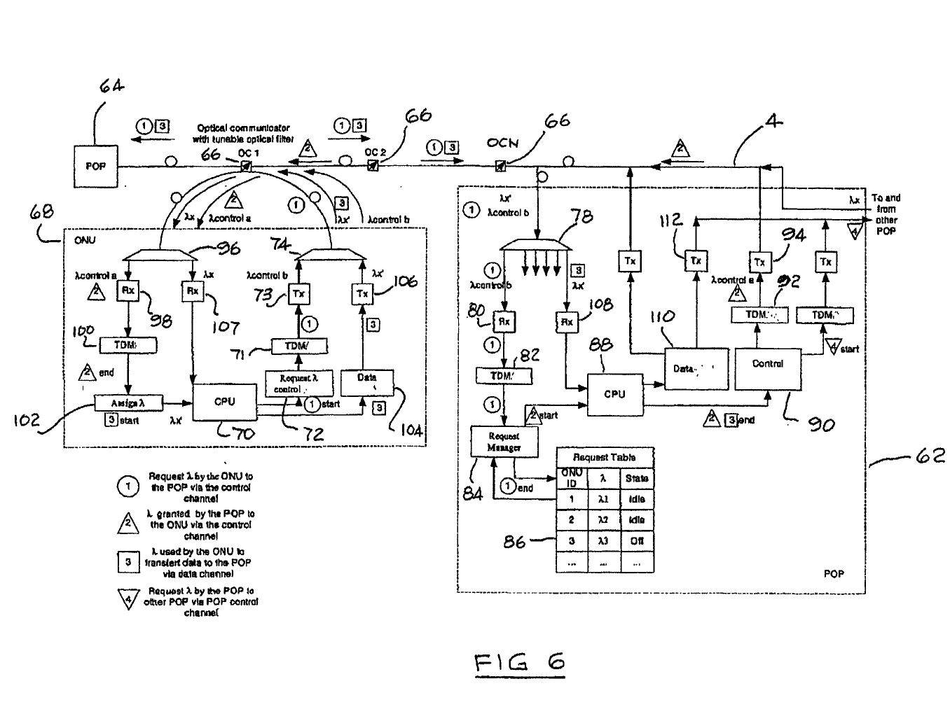

In the CAN configuration, the routing of information is usually limited to one pathway and all the data present in the CAN will be using the same bus line. The CAN configuration is defined as one in which an ONU wants to communicate with another ONU and both ONUs share the same link 4. Referring to FIG. 5, a CAN 10 comprises POP units 42 and 44 connected with the link 4. ONUs 46-54 are connected to the link 4 by means of optical communicator 58 and 60. Several wavelengths are also necessary on this case. As an example, assume that ONU 48 needs to communicate with ONU 56 using λ1 for the transmission. At the optical communicator 58, the information will be directed in both directions. A portion of the power will reach the POP unit 42 and the remaining power will be directed toward the proper direction in the link and will reach the appropriate optical communicator 60 that will redirect the data traveling on wavelength λ1 toward ONU 56. At the same time, ONU 56 can communicate with ONU 48 using another wavelength λ3. Assume there is a break of the link between the optical communicators 58 and 60. The bi-directionality of the system enables the data sent by ONU 48 to reach POP unit 42 and the data sent by ONU 56 to reach POP unit 44. In both cases, the data will migrate to the MAN level, be routed toward the proper POP units to finally reach the final destination. Before sending a data signal, ONU 48 sends a control signal to POP 42 that informs the network of its intentions. POP unit 42 then orders all optical communicators to adopt a configuration to properly route the data signal sent by ONU 48. The routing procedure is also applicable, using another wavelength λ2 for connecting, for example, POP unit 42 to POP unit 44. In the CAN configuration, all ONUs are informed at all times on the network status by a broadcast signal emitted by one or both of the POP units 42 and 44.

On each link 4, the control channel consists of either two wavelengths, for example, λcontrola and λcontrolb shown in FIG. 5, one in each direction, or one wavelength alternately in each direction (half duplex mode). Any spare bandwidth on the control channel can be used for payload transport in a manner similar to the bandwidth of the payload channels except that the POP units and the ONUs must wait for gaps between the control portions of the signal to transmit their payload. When two wavelengths are used, the pair of wavelengths is assigned for transmit and receive in opposite manner at a primary POP unit and at the secondary POP unit at the other end of the shared link. When one wavelength is used alternately in each direction, the two POP units at the end of the link take turn in initiating the transmission on the control wavelength. In all cases, the transmitting POP unit sends the framing information, the control information destined to the ONUs on the shared link, as well as the payload when only a portion of the wavelength bandwidth is used by the downstream control wavelength. The control wavelength transmitted by a primary POP unit is called the downstream control wavelength. The control wavelength transmitted by a secondary POP unit is called the upstream control wavelength. When the ONUs on a shared CAN have different primary POP units, the downstream control wavelength of some ONUs is the upstream control wavelength of the others.

In all cases, a suitable framing pattern is used on each link to permit frame delimiting, synchronization and error detection or recovery. IEEE 802.3 is one such possible framing pattern.

For the CAN span of control with centralized control, the control channel operates, for example, in Time Division Multiplexing (TDM) mode with one or more time slots permanently assigned to each ONU or in Time Division Multiple Access (TDMA) mode where the time slots are assigned dynamically on demand. In the permanent assignment mode (TDM), an ONU reads from the downstream control wavelength the information contained in reserved time slots within the frame pattern. As well, the same ONU writes its control information or payload on the upstream control wavelength during the fixed time slots allotted to it. In the dynamic assignment mode (TDMA), the primary POP unit writes on the downstream control wavelength one or more frames that contain the identifier of the ONU and the position of the time slots destined for that ONU, or alternately, the identifier of the ONU followed by the control information or payload destined to that ONU.

In the centralized control mode, the ONU requests a permission to transmit to a specific destination ONU or set of ONUs on the same CAN or on different CANs. Then the primary POP unit grants to that ONU permission to use a particular wavelength, i.e., a free wavelength to communicate with the primary POP unit and from there, directly or indirectly to the primary POP units of the destination ONUS. Permission is granted either for a fixed or negotiable period of time, possibly for the duration of a packet, or until the ONU informs its primary POP unit that the wavelength is no longer needed. The primary POP unit also sends control signals and payload information to a particular ONU on the wavelength identified on the downstream control wavelength.

For the distributed control of the CAN span, an ONU writes on a time slot of the upstream control wavelength a token indicating which of the free wavelengths it wishes to select, in particular the wavelength(s) of the destination ONU(s) when they are connected to the same CAN. The primary POP writes on the downstream control wavelength the status of all wavelengths based on the token it reads from the upstream control wavelength. The status is either in use, available or contention. The latter status indicates that more than one ONU have requested the same wavelength. When an ONU reads that the requested wavelength is marked [symbol] available [symbol] , it begins transmitting. When it reads that the requested wavelength is marked [symbol] contention [symbol] , it writes a token for another wavelength selected in a random fashion for a destination ONU on a different CAN. If the wavelength assigned to the destination ONU(s) on the same CAN is or are in use, the originating ONU either waits until it sees the corresponding wavelength marked [symbol] available [symbol] or else it keeps on issuing tokens for that particular wavelength during a certain time interval.

In the CAN, the uncontrolled mode, also referred to as Optical Sense Multiple Access with Collison Detection or OSMA/CD consists in an ONU listening with a WDM receiver to all wavelengths on the link, then selecting a free wavelength to transmit its signal. The ONU then monitors that wavelength to detect any possible collision with the transmission of another or more ONUs in the same CAN. All ONUs that detect a collision on a given wavelength stop transmitting, then resume listening to all wavelengths. The selection of one wavelength among all free wavelengths is done in a random fashion to reduce the probability of a subsequent collision.

For the MAN span of control, each POP unit transmits to its neighbors the status of all its CANs, in particular those for which it is the primary POP. Through a routing mechanism, the POP units discover one or multiple alternate paths to their secondary POP units. Whenever a primary POP unit and its associated secondary POP unit discover through the alarm indication contained in the CAN control channel that they have lost communication with a segment of the CAN, they communicate among themselves to activate the alternate path and to change the secondary POP unit status to temporary primary POP unit. Similarly upon recovery of the communication between the primary POP unit and all its associated ONUs, the primary and temporary primary POP units negotiate the return of the latter to its default secondary status.

Furthermore the POP units inform each other of the availability of specific wavelengths on the inter-POP links. The POP units may use such information to reserve a free wavelength and to assign it to an originating ONU in order to avoid unnecessary wavelength conversion at intermediate POP units, especially in situations where the power budget of a POP unit would allow it to reach the primary POP unit of the destination ONU without regeneration.

The control system, in summary, provides the means for managing the dynamic allocation of wavelengths between the various ONUs and the POP units. The control system carries information about the availability of the various wavelengths on the various links of the CAN and the MAN, as well as the network timing adjustments such as, but not limited to, wavelength stabilization delay and bit rate control. The control system has two spans of control, namely, the MAN span for the exchange of control signal and messages between POP units on the one hand, and the CAN span for the exchange of control signals and messages between each POP unit and all the ONUs for which it is the primary POP unit. The control system can be either centralized or distributed. In the CAN span, a third mode is possible, namely, the uncontrolled mode where the ONUs uses an Optical Sense Multiple Access/Collision Detection (OSMA/CD) method of choosing wavelength.

Referring to FIG. 6, a general illustrative functional block diagram of the control system used to manage the dynamic allocation of wavelengths between the various ONUs and the POP units is disclosed. Primary POP unit 62 and secondary POP unit 64 are connected to the link 4. Multiple optical communicators 66 are operably connected to the link 4. An ONU 68 is shown connected to one of the optical communicators 66.

At the ONU 68, a CPU 70 requests a wavelength channel via the control plane 72. The term “control plane” refers to the signaling protocol, the exchange of control information between communicating entities and that part of the communicating equipment that enable these entities to handle and process the information which is the actual object of the exchange between the communicating entities. The request is filled in the time slot assigned to the ONU 68 either permanently in a TDM system or on demand TDMA system. TDM will be used herein in a generic sense to mean either system. The information is launched at the appropriate wavelength (λcontrolb) via the TDM 71 and the optical transmitter 73 to the bi-directional link 4 from an optical multiplexer 74 and the optical communicator 66. At the primary POP unit 62, the information is dropped and follows a path through a demultiplexer 78 to an optical receiver 80 to a TDM 82 and finally to a Request Manager 84 that consults a Request Table 86 to find an available and appropriate wavelength to assign the ONU 68. This assignment is made as a function of the desired final destination (contained in the control message) of the ONU message. For this discussion, assume that the ONU 68 wants to communicate with an ONU outside the community area network. Once the Request Table 86 has selected and returned the wavelength to the Request Manager 84, the information concerning the wavelength assignment and other network information is sent from a CPU 88 to the control plane 90. The control plane 90 sends the control information via the TDM 92 and the optical transmitter 94 to the link 4, using the appropriate wavelength (λ control a). The wavelength is dropped by the optical communicator 66, the demultiplexer 96 sends the information to the appropriate detector 98, the TDM 100 reads the control channel and a wavelength λx′ is assigned at 102 to the ONU 68.

In the data plane, the CPU 70 sends the data bit stream to the optical transmitter 106 for modulation. The term “data plane” refers to that part of the communicating equipment and the communication channel that actually handle and process the information (or data) which is the actual object of the exchange between the communicating entities. The modulated signal at wavelength λx′ is sent back to the link 4 via the optical communicator 66. When the signal is intended to an external ONU and has to transit via the POP unit 62, all the filters in the optical communicators 66 in the pathways of the signal are adjusted (default value) in a way to let the wavelength to go by unaltered. When the signal is intended to an ONU in the community area network, the optical communicator serving the node adjusts its filters in order to drop the wavelength toward the ONU.

In the example shown in FIG. 6, the signal reaches the POP unit 62, is separated by the demultiplexer 78, detected by the receiver 108 and processed by the CPU 88. The wavelength is then marked available in the Request Table 86 when the ONU releases the channel wavelength via the signalling control plane. The CPU 88 pushes the data 110 and sends the bit stream to the transmitter to the MAN, via a neighbor link, using the appropriate wavelength designated by the Request Table. The POP unit 62 may be equipped with an optical cross-connect or an optical switch to enable optical throughput where wavelengths can be transferred directly from one end of the POP unit to the other without the need for optical-electrical-optical transformation. If some wavelengths need regeneration, they can be dropped at the POP unit by a standard add/drop device to the photodetector.

The transmitter 106 used in the ONU may be broad-spectrum optical sources including a channel defining assembly, such as channel filter selectors, for resolving the output of the broad-spectrum optical sources. The optical transmitters can also be multiple laser sources, WDM laser sources or tunable laser sources. The optical transmitters are standard equipment. The transmitter optical source is controlled by the appropriate control circuitry, which is constantly informed of the network condition by the control system, as described above, to set the wavelengths at the output of the optical source of the transmitter such that no transmitters are set to the same wavelength simultaneously. The wavelength selection is done based on the existing wavelengths propagating in the network.

Receiver 107 is a WDM receiver.

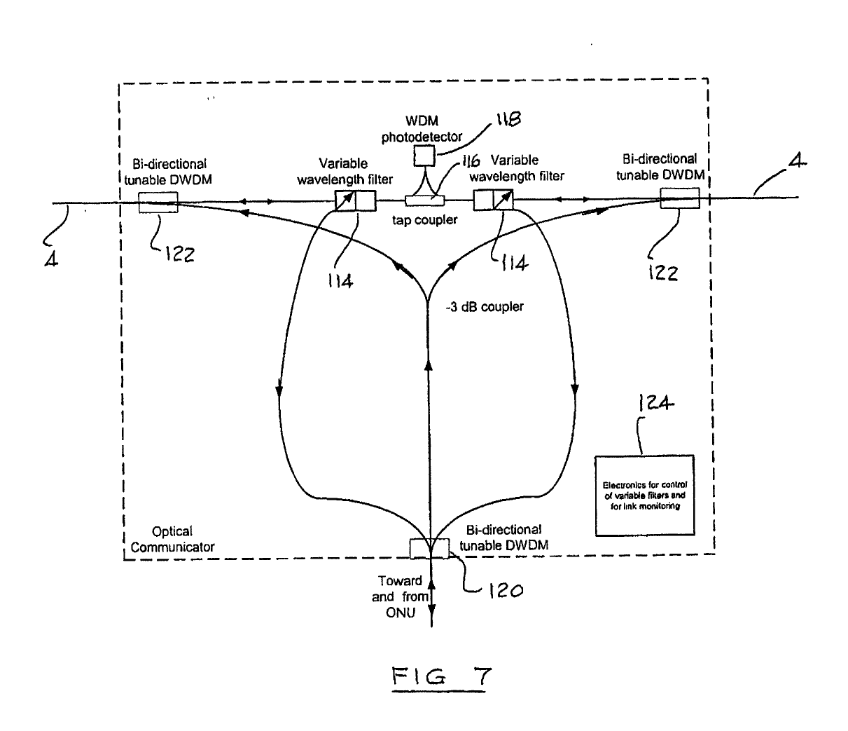

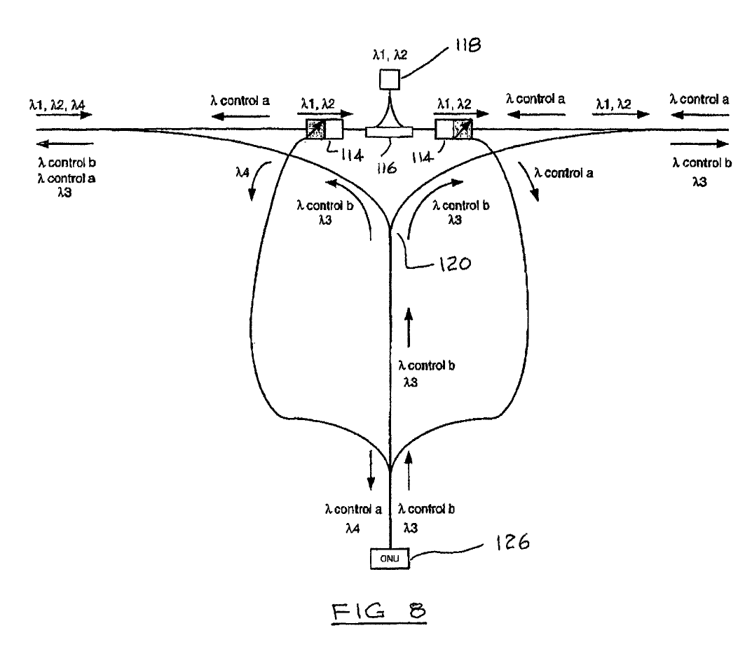

Referring to FIG. 7, an illustrative embodiment of the communicator 22 is disclosed as a tree-port WDM device 112 based on thin-film technology. Variable wavelength filters 114 provide an add/drop function to select the proper wavelength between the N wavelengths launched at the POP unit or any other local node and redirect it to the node's transceiver electro-optical interface at the ONU. A tap 116 monitors the other wavelengths traveling through the community network through a WDM photodetector 118. A −3 db coupler 120 enables the signal launched from the ONU to be sent bi-directionally toward both POP units at the end of the optical link. A bi-directional coupler 120 is provided. Couplers 122 are also provided. An electronic control circuitry 124 provides control of the variable filters 114 and for link monitoring associated with the WDM photodetector 118.

Referring to FIG. 8, assume that a control signal from the ONU at λcontrolb is launched from the ONU 126. The signal is split at the −3 db coupler 120 and reaches both POP units at both ends of the optical link 4. Assume that the principal POP unit is at the right of the link. The POP unit processes the control signal as previously described in connection with FIG. 6. A control signal λcontrola is then launched by the POP unit toward all optical communicators. Each variable wavelength filter 114 drops this control wavelength (λcontrola) toward their respective ONU for processing. Once the ONU has processed the control signal, it launches the data signal, for example, λ3, in the link. The −3 db coupler 120 enables the data signal λ3 to be sent bi-directionally toward both ends of the optical link 4. In the meantime, other wavelengths λ1, λ2 and λ4 can travel in the optical link. Assume that λ4 is intended for the ONU 126. The variable wavelength filter 114 would be set to filter λ4 and therefore direct the signal toward the ONU 126 while λ1 and λ2 would go through the device 112 unaltered. The tap 116 monitors the link to inform each ONU if a signal, at a particular wavelength that was intended for the ONU, was not properly filtered and re-directed to the ONU. The tap 116 can also monitor all the wavelengths traveling in the link 4.

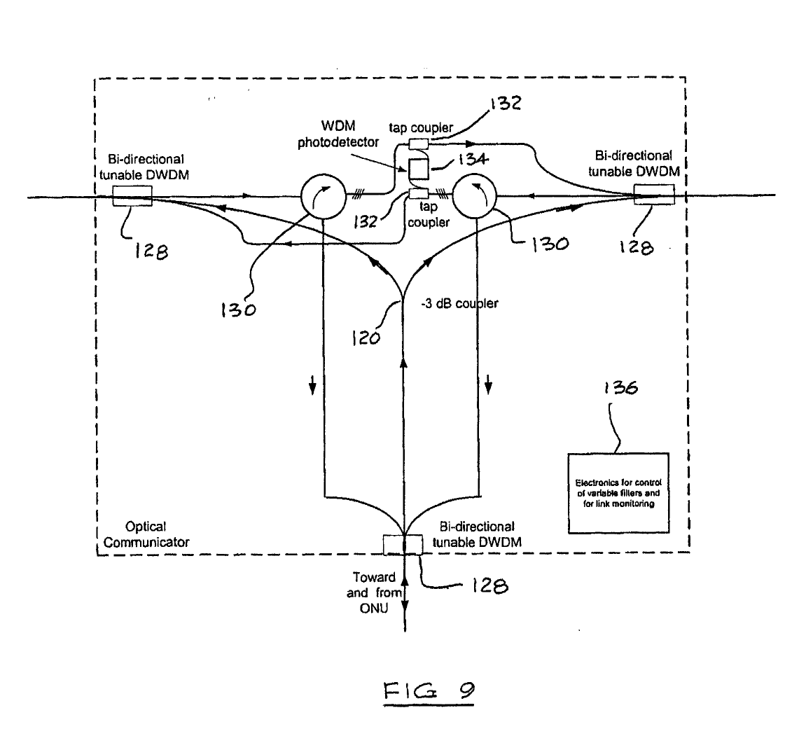

Another embodiment of the optical communicator 22 is disclosed in FIG. 9. Bi-directional tunable wavelength division multiplexers 128 enable the routing of the signal at the fiber junctions. Circulators route the signals to the appropriate paths. Tap couplers 132 and WDM photodetectors 134 provide link monitoring. Controller 136 provides control of the bi-directional tunable WDMs 128.

The present invention provides a scalable, bidirectional, multi-channel, active optical transport system. By integrating active optical modules in a bus topology with two POP units, one at each end of the linear link, the system offers a design suitable for easy and scalable integration in a mesh MAN network. The MOCAN can be integrated into an artificial intelligence network, defined as a network that has the ability of intelligent bandwidth management.

The MOCAN is based on a bus architecture connected at both ends by a POP unit, which enables the network to easily adopt CAN or mesh MAN architecture. An active, dynamic on-demand wavelength allocation (ODWA) enables the network to operate in the CAN or MAN architecture. By using the optical communicator disclosed herein, the signal can be bi-directionally transmitted into the optical link for redundancy. Therefore, at any time, even in the case of a link cut, the ONU has a direct contact with one of the POP units. The network is built around a WDM concept to maximize its bandwidth capabilities. Furthermore, it integrates tunable or selectable sources and filters for maximum network optimization. No previous network architecture integrates all the mentioned functions and offers simultaneously an easily scalable network with CAN and MAN capabilities, one-fiber redundancy (bi-directionality) and dynamic WDM-based switching multi-channeling capabilities with wavelength allocation under the supervision of a control channel.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

We claim:

1. An optical network for the transfer of data between optical network units (ONU) connected to respective data terminal equipment including electro-optical interface for converting electrical signals to optical signals for transmission through the optical network and for converting optical signals to electrical signals for input to the terminal equipment, comprising:
a) a fiber optic line having first and second ends;
b) first and second point-of-presence (POP) units connected to respective first and second ends of said fiber optic line, said first and second POP units for being connected to another optical network, said first and second POP units including optical multiple wavelength apparatus for optical signal generation and optical multiple wavelength apparatus for optical signal detection;
c) first and second optical communicators connected to said fiber optic line at locations either between said first and second POP units or attached to the same or different POP units;
d) first and second ONUs operably connected to respective said first and second optical communicators, said first and second ONUs being associated with respective first and second data terminal equipment;
e) said first optical communicator being configured to transmit a first wavelength signal bi-directionally from said first ONU to both said first and second POP units, said first optical communicator including a first add/drop module operably connected to said fiber optic line to drop a second wavelength signal from said fiber optic line intended for said first ONU;
f) said second optical communicator being configured to transmit a third wavelength signal bi-directionally from said second ONU to both said first and second POP units, said second optical communicator including a second add/drop module operably connected to said fiber optic line to drop a fourth wavelength signal from said fiber optic line intended for said second ONU;
g) said first and second ONUs each including optical multiple wavelength apparatus for optical generation and optical wavelength apparatus for optical detection; and
h) control system means for allocating wavelengths between said first and second ONUs and said first and second POP units.

2. An optical network as in claim 1, wherein:
a) said optical multiple wavelength apparatus for optical generation for said ONUs includes a broad spectrum optical source; and
b) a channel defining assembly for resolving the output of said broad spectrum optical source.

3. An optical network as in claim 1, wherein:
a) said optical multiple wavelength apparatus for optical generation said ONUs includes multiple laser sources.

4. An optical network as in claim 1, wherein:
a) said optical multiple wavelength apparatus for optical generation for said ONUs includes a WDM laser source.

5. An optical network as in claim 1, wherein:
a) said optical multiple wavelength apparatus for optical generation for said ONUs includes a tunable laser source.

6. An optical network as in claim 1, wherein said optical multiple wavelength apparatus for optical detection for said ONUs includes a WDM receiver.

7. An optical network as in claim 1, wherein:
a) said optical multiple wavelength apparatus for optical generation for said POP units includes a broad spectrum optical source; and
b) a channel defining assembly for resolving the output of said broad spectrum optical source.

8. An optical network as in claim 1, wherein:
a) said optical multiple wavelength apparatus for optical generation said POP units includes multiple laser sources.

9. An optical network as in claim 1, wherein:
a) said optical multiple wavelength apparatus for optical generation for said POP units includes a WDM laser source.

10. An optical network as in claim 1, wherein:
a) said optical multiple wavelength apparatus for optical generation for said POP units includes a tunable laser source.

11. An optical network as in claim 1, wherein said optical multiple wavelength apparatus for optical detection for said POP units includes a WDM receiver.

12. An optical network as in claim 1, wherein each of said first and second optical communicators comprises:
a) a first coupler connected to said first and second add/drop modules and a respective ONU;
b) a second coupler connected to said first coupler;
c) third and fourth couplers connected to said fiber optic line at locations outboard of said first and second add/drop modules;
d) said second coupler is connected to said first and second fourth couplers;
e) wherein said first or second wavelength signal from said first or second ONU, respectively, passes through said first coupler and splits at said second coupler to proceed to respective said third and fourth couplers to respective said first and second POP units;
g) wherein said second wavelength signal in said fiber optic line intended for said first ONU is dropped by one of said first and second add/drop modules and sent to said first coupler and then to said first ONU; and
h) wherein said first wavelength signal in said fiber optic line intended for said second ONU is dropped by one of said first and second add/drop modules and sent to said first coupler and then to said second ONU.

13. A network as in claim 12, wherein said first and second add/drop modules include variable wavelength filters.

14. A network as in claim 12, and further comprising:
a) a tap connected to said fiber optic line between said first and second add/drop modules; and
b) a WDM photodetector connected to detect wavelengths passing between said first and second add/drop modules, thereby to monitor the wavelengths passing through said fiber optic line.

15. A network as in claim 12, wherein:
a) said first and second add/drop modules include first and second circulators, respectively;
b) said third and fourth couplers include first and second tunable wavelength division multiplexers, respectively; and
c) said first coupler includes a bi-directional tunable wavelength division multiplexer.

16. A network as in claim 1, and further comprising a star coupler connected between said first or second optical communicator and said first or second ONU.

17. A network as in claim 1, and further comprising a switch coupler connected between said first or second optical communicator and first or second ONU.

18. A method for transferring data between a first optical network unit (ONU) to a second ONU, comprising:
a) providing a fiber optic line between first and second point-of-presence (POP) units;
b) connecting first and second optical communicators to the fiber optic line at locations between the first and second POP units, each optical communication including an add/drop module;
c) connecting the first and second ONUs to the respective first and second optical communicators;
d) designating one of the first and second POP units to be a primary POP unit for the first ONU; and
e) assigning a wavelength to be used by the first ONU to transmit data signal to the second ONU;
f) adjusting the add/drop module of the second optical communicator to drop the data signal at the assigned wavelength to the second ONU;
g) sending the data signal on the assigned wavelength through the first optical communicator whereby the data signal is sent to both the first and second POP units through the fiber optic link; and
h) informing the primary POP unit that the assigned wavelength is no longer needed.

19. A method as in claim 18, wherein said assigning comprises:
a) requesting permission from the primary POP unit to transmit data signal to the second ONU; and
b) granting to the first ONU permission to use the assigned wavelength to transmit the data signal.

20. A method as in claim 18, wherein said assigning comprises:
a) providing a first control channel for use by the first ONU for requesting the particular wavelength from the primary POP unit; and
b) providing a second control channel for use by the primary POP unit for granting use of the particular channel to the first ONU.

21. A method as in claim 18, wherein said assigning comprises:
a) providing a first control channel;
b) writing by the first ONU on the first control channel a token indicating which wavelength it wishes to use;
c) providing a second control channel indicating the status of the requested wavelength; and
d) using the requested wavelength if available to transmit the data signal.

22. A method as in claim 18, wherein said assigning comprises:
a) listening by the first ONU with a WDM receiver to all wavelengths in the fiber optic line; and
b) selecting a free wavelength to transmit the data signal.

23. A method as in claim 20, wherein the first and second control channels are operated in time division mutliplexing mode.

24. A method as in claim 20, wherein the first and second control channels are operated in time division multiple access mode.

25. A method as in claim 18, wherein the first and second optical communicators are implemented with variable wavelength filters.

26. A method as in claim 18, wherein the first and second optical communicators are implemented with circulators and tunable wave division multiplexers.
